(19) United States
(12) Patent Application Publication
(10) Pub. No.: US 2026/0102705 A1
(43) Pub. Date: Apr. 16, 2026

(54) METHOD AND COMPUTERIZED SYSTEM FOR CONTROLLING VIRTUAL CHARACTER IN GAME, AND COMPUTER READABLE STORAGE MEDIUM

(71) Applicant: Yidian Lingxi Information Technology (Guangzhou) Co., Ltd., Guangdong (CN)

(72) Inventor: Weili Xiong, Guangdong (CN)

(73) Assignee: Yidian Lingxi Information Technology (Guangzhou) Co., Ltd., Guangdong (CN)

(21) Appl. No.: 19/030,925

(22) Filed: Jan. 17, 2025

(30) Foreign Application Priority Data
Oct. 14, 2024 (CN) 202411433199.7

(51) Int. Cl. A63F 13/56

(52) U.S. Cl. CPC A63F 13/56

(57) ABSTRACT

The disclosure provides a method for controlling a virtual character for implementation by a computer that executes a game, a computerized system for controlling a virtual character in a game, and a non-transitory computer-readable storage medium, and relates to the technical field of game data processing. The method includes: displaying a first scene area of a first game scene on a game interface; and based on the second position and the first position, performing a first chase directive of the second virtual character towards the first virtual character on the game interface. The first chase directive comprises: displaying, on the game interface, a part of the first movement route taken by the second virtual character towards the first virtual character within the first scene area; wherein the first movement route is determined based on the second position and the first position.

### CROSS-REFERENCE TO RELATED APPLICATION

This application claims priority to Chinese Patent Application No. 202411433199.7, filed on Oct. 14, 2024, which is hereby incorporated by reference in its entirety.

### TECHNICAL FIELD

The present disclosure relates to the technical field of game data processing, and particularly, to a method for controlling a virtual character for implementation by a device that executes a game, a computerized system for controlling a virtual character in a game, and a non-transitory computer-readable storage medium.

### BACKGROUND

In Role-playing games (RPGs), users can assume the role of one or more characters and engage in activities within one or more game scenes. In such games, one or more virtual characters may initiate attacks on the user-controlled virtual character(s). Users often find it challenging to perceive the number and orientation of these attacking virtual characters, which complicates decision-making when the attacking virtual characters are close by. This difficulty can detract from the user's gaming experience.

### SUMMARY

One objective of an embodiment of the present disclosure is to provide a new technical solution of a method for controlling virtual characters.

According to a first aspect of the present disclosure, a method for controlling virtual characters for implementation by a device that executes a game is provided, the method including:
Displaying, by a processor, a first scene area of a first game scene on a game interface; wherein the first game scene includes a user-controlled first virtual character, and a second virtual character that targets the first virtual character as an attack target, with the first virtual character located at a first position within the first scene area, and the second virtual character located at a second position within the first game scene; and
based on the second position and the first position, performing, by the processor, a first chase directive of the second virtual character towards the first virtual character on the game interface; wherein
the first chase directive includes: displaying by the processor, on the game interface, a part of the first movement route taken by the second virtual character towards the first virtual character within the first scene area; wherein the first movement route is determined based on the second position and the first position.

In a possible implementation, in a case where the second position is located within a second scene area of the first game scene, the first chase directive further includes: displaying, by the processor, a character symbol representing the second virtual character at a third position within the first scene area; wherein the second scene area is a scene area that is currently not displayed on the game interface, and the third position is determined based on the first position and the second position.

In a possible implementation, the method further includes:
Initiating, by the processor, the first chase directive based on triggering of a first preset event by the first virtual character within the first scene area.

In a possible implementation, said “initiating, by the processor, the first chase directive based on triggering of a first preset event by the first virtual character within the first scene area” includes:
setting, by the processor, the second virtual character, associated with the first game scene, to appear in the first game scene based on triggering of a first preset event by the first virtual character within the first scene area; and
initiating, by the processor, the first chase directive based on appearance of the second virtual character in the first game scene.

In a possible implementation, the first preset event is any one event in a preset events set, and the preset events set includes at least one of the following events: the first virtual character moves to a preset position within the first scene area; a staying duration of the first virtual character within the first scene area reaches a preset duration; the number of steps taken by the first virtual character within the first scene area exceeds a preset step count; and the first virtual character completes a preset quest within the first scene area.

In a possible implementation, the first chase directive further includes: marking, by the processor, an actual distance of the first movement route in the first game scene on at least one of the character symbol and the first movement route.

In a possible implementation, said “performing a first chase directive of the second virtual character towards the first virtual character” includes:
at a first time point, performing, by the processor, a first chase directive corresponding to the first time point based on a second position of the second virtual character at the first time point and a first position of the first virtual character at the first time point;
at a second time point after the first time point, performing, by the processor, a first chase directive corresponding to the second time point based on a second position of the second virtual character at the second time point and a first position of the first virtual character at the second time point;
wherein in a case where a second preset event occurs, an actual movement route of the second virtual character from the first time point to the second time point deviates from a first movement route directed by the first chase directive corresponding to the first time point.

In a possible implementation, the method further includes:
in response to the first virtual character switching to a second game scene, displaying, by the processor, a third scene area of the second game scene on the game interface; wherein the first virtual character is located in the third scene area;
in a case where the second virtual character is still alive in the first game scene, causing, by the processor, the second virtual character to appear in the second game scene; and
performing, by the processor, a second chase directive of the second virtual character towards the first virtual character on the game interface.

In a possible implementation, the method further includes:
in response to the first virtual character switching to a second game scene, displaying, by the processor, a third scene area of the second game scene on the game interface; wherein the second game scene includes the first virtual character, and the second virtual character that targets the first virtual character as an attack target, with the first virtual character located within the third scene area, and while a second virtual character in the first game scene and a second virtual character in the second game scene are different virtual individuals, they share the same character model.

According to a second aspect of the present disclosure, a computerized system for controlling a virtual character in a game is further provided, which includes: an interface display; a memory, configured for storing a computer program; and a processor, configured for executing operations under control of the computer program, the operations comprising:
displaying by a processor, a first scene area of a first game scene on a game interface; wherein the first game scene includes a user-controlled first virtual character, and a second virtual character that targets the first virtual character as an attack target, with the first virtual character located at a first position within the first scene area, and the second virtual character located at a second position within the first game scene;
based on the second position and the first position, performing, by the processor, a first chase directive of the second virtual character towards the first virtual character on the game interface; wherein the first chase directive includes: displaying by the processor, on the game interface, a part of the first movement route taken by the second virtual character towards the first virtual character within the first scene area; wherein the first movement route is determined based on the second position and the first position.

According to a third aspect of the present disclosure, a non-transitory computer-readable storage medium is provided, which stores instructions, when executed by a processor, cause the processor to perform a method for controlling a virtual character in a game, the method comprising: displaying, by a processor, a first scene area of a first game scene on a game interface; wherein the first game scene comprises a user-controlled first virtual character, and a second virtual character that targets the first virtual character as an attack target, with the first virtual character located at a first position within the first scene area, and the second virtual character located at a second position within the first game scene; and based on the second position and the first position, performing, by the processor, a first chase directive of the second virtual character towards the first virtual character on the game interface; wherein the first chase directive comprises: displaying by the processor, on the game interface, a part of the first movement route taken by the second virtual character towards the first virtual character within the first scene area; wherein the first movement route is determined based on the second position and the first position.

According to a fourth aspect of the present disclosure, a computer program product is further provided, which contains a game program. The game program, when executed, causes a computer to execute steps of the above method for controlling a virtual character.

According to a fifth aspect of the present disclosure, an electronic device is further provided, which includes a memory and a processor. The memory stores a computer program therein, and the processor is configured for executing the above method for controlling a virtual character through the computer program.

A beneficial effect of the embodiment of the present disclosure is that, within the first scene area, it displays the activities of the first virtual character controlled by the user; furthermore, when the second virtual character targets the first virtual character as an attack target, it displays the part, which is within the first scene area, of the first movement route of the first virtual character. This clearly shows the first movement route to the user, effectively alerting the user to the chase of the first virtual character by the second virtual character. This feature helps provide the user with effective information for making the next decision regarding the first virtual character, thereby enhancing the user's gaming experience.

The features of the embodiments of the present specification and their advantages will become clear through the following detailed description of the exemplary embodiments of the present specification with reference to the accompanying drawings.

### BRIEF DESCRIPTION OF THE DRAWINGS

The accompanying drawings, which are incorporated in and constitute a part of the specification, illustrate embodiments of present disclosure and, together with the description thereof, serve to explain the principles of the disclosed embodiments.

FIG. 1 illustrates a schematic diagram of the hardware structure of an electronic device that can be used to implement a method for controlling a virtual character according to an embodiment of the present disclosure;

FIG. 2 illustrates a flow schematic diagram of the method for controlling a virtual character according to some embodiments;

FIG. 3 illustrates a schematic diagram of the first scene area of a first game scene according to some embodiments;

FIG. 4 illustrates a schematic diagram of the first scene area of the first game scene according to other embodiments;

FIG. 5 illustrates a schematic diagram of the first game scene according to other embodiments;

FIG. 6 illustrates a schematic diagram of a third scene area of a second game scene according to other embodiments;

FIG. 7a illustrates a schematic diagram of a game scene layout according to other embodiments;

FIG. 7b illustrates a schematic diagram of the game scene layout according to other embodiments;

FIG. 7c illustrates a schematic diagram of the game scene layout according to other embodiments;

FIG. 8 illustrates a structural schematic diagram of an apparatus for controlling a virtual character according to some embodiments;

FIG. 9 illustrates a schematic diagram of the hardware structure of an electronic device according to some embodiments.

FIG. 10 illustrates a schematic diagram of an operating environment of a computerized system for controlling a virtual character in a game according to some embodiments.

### DETAILED DESCRIPTION

Various exemplary embodiments of the present specification will now be described in detail with reference to the accompanying drawings.

The following description of at least one exemplary embodiment is in fact merely illustrative and is in no way intended as a limitation to the present disclosure and its application or use.

It should be noted that similar reference numerals and letters represent similar items in the accompanying drawings below. Therefore, once an item is defined in one drawing, it is unnecessary to further discuss the item in the subsequent drawings.

It should be noted that all actions to obtain signals, information or data in embodiments of this specification are performed in compliance with the corresponding data protection regulations and policies of the country in which they are located, and with authorization from owners of the corresponding devices.

It should also be noted that the terms “first”, “second”, etc., in the specification and claims of the present disclosure and the accompanying drawings described above are used to distinguish between similar objects and need not be used to describe a particular order or sequence.

It should be understood that the data so used may be interchangeable, where appropriate, so that the embodiments of the present disclosure described herein can be implemented in an order other than those illustrated or described herein. In addition, the terms “comprising” and “having”, and any variations thereof, are intended to cover non-exclusive inclusion, e.g., a process, method, system, product or device comprising a series of steps or units need not be limited to those clearly listed, but may comprise other steps or units that are not clearly listed or are inherent to those processes, methods, products or device.

The present disclosure is directed to a game application (APP) and provides a technical solution for a virtual character participating in a game to display a chase route of a chasing target when the virtual character is being chased. This feature offers the users effective information for making their next decision, thereby enhancing their gaming experience. According to the embodiments of the present disclosure, the first virtual character refers to one or more characters operated and controlled by the user participating in the game during the game process. Under user control, the first virtual character engages in various activities within the game scene, which may include but are not limited to, moving, attacking, accepting game quests, executing game quests, or completing and submitting game quests.

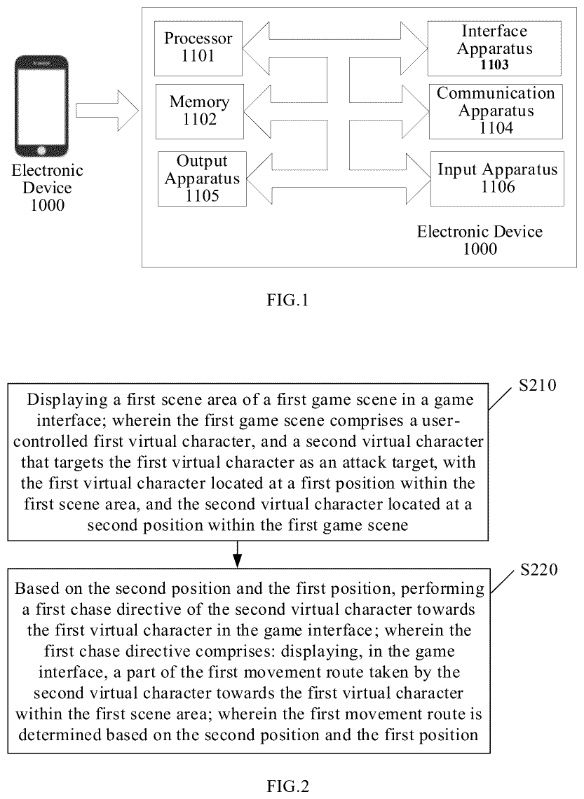

FIG. 1 illustrates a schematic diagram of the hardware structure of an electronic device that can be used to implement a method for controlling a virtual character according to an embodiment of the present disclosure.

The electronic device 1000 is a device capable of running the above-described game, and may be a cell phone, a tablet computer, a PC, a server, and the like, which is not limited herein.

As shown in FIG. 1, the electronic device 1000 may comprise a processor 1101, a memory 1102, an interface apparatus 1103, a communication apparatus 1104, an output apparatus 1105, an input apparatus 1106, and so on. The hardware configuration depicted in FIG. 1 is illustrative only and is not intended to limit the present disclosure, its applications, or uses.

The processor 1101 executes computer programs that can be written using instruction sets for architectures such as x86, Arm, RISC, MIPS, SSE, among others. The memory 1102 comprises, for example, ROM (Read-Only Memory), RAM (Random Access Memory), non-volatile storage such as hard drives, etc. The interface apparatus 1103 comprises, for example, a USB interface, a network cable interface, an earphone interface, etc. The communication apparatus 1104 supports both wired and wireless communications, and can comprise at least one short-range communication module, such as any module for short-range wireless communication based on short-range wireless communication protocols such as Hilink protocol, WiFi (IEEE 802.11 protocol), Mesh, Bluetooth, ZigBee, Thread, Z-Wave, NFC, UWB, LiFi, etc. The communication apparatus 1104 can further comprise a remote communication module, such as any module for WLAN, GPRS, 2G/3G/4G/5G remote communication. The output devices 1105, for example, can comprise LCD screens or touchscreens, speakers, etc. The input devices 1106, for example, can comprise touchscreens, keyboards, microphones, various sensors, etc.

In the present embodiment, the memory 1102 of the electronic device 1000 is configured for storing a computer program that controls the operation of the processor 1101 to perform the method for controlling a virtual character according to any embodiment of the present disclosure.

Next, various embodiments of the present method are illustrated.

### First Embodiment

FIG. 2 illustrates a method for controlling a virtual character according to some embodiments, wherein the present embodiment takes a user-controlled first virtual character being chased as an example to illustrate corresponding method steps. The method may include the following steps S210 and S220:
Step S210: displaying a first scene area of a first game scene on a game interface; wherein the first game scene includes a user-controlled first virtual character, and a second virtual character that targets the first virtual character as an attack target, with the first virtual character located at a first position within the first scene area, and the second virtual character located at a second position within the first game scene.

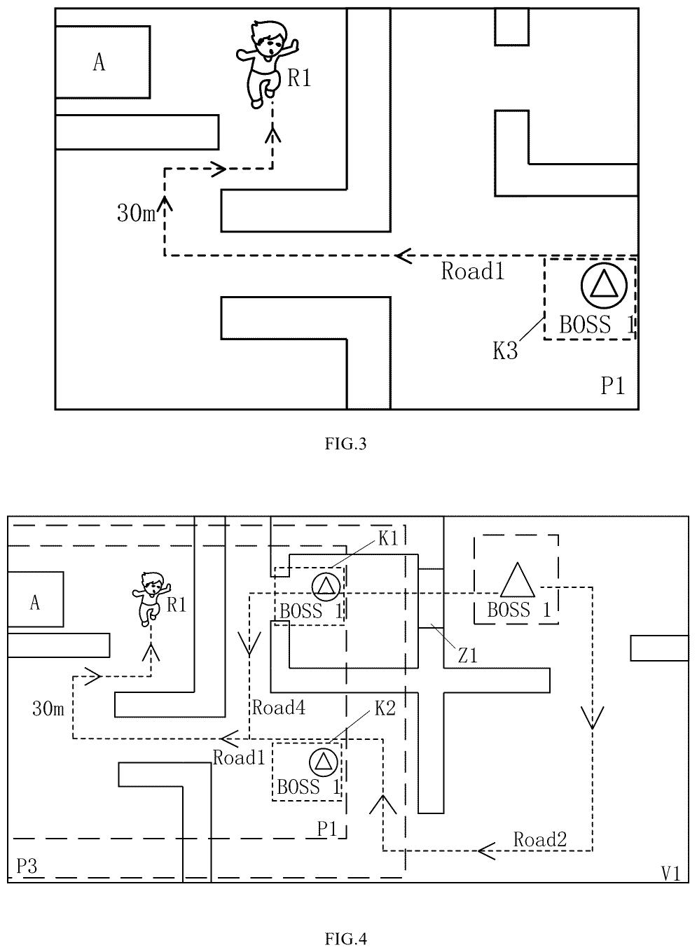

In the present embodiment, the first scene area is at least a part of the game area where the first virtual character is located. The game interface can display the entire game area of the first game scene, meaning that the first scene area is the entire game area. Taking the game interface in FIG. 3 as an example, the scene area P1 is the entire game area of the first game scene, the virtual character R1 represents the first virtual character, the virtual character BOSS 1 represents the second virtual character, and the virtual character R1 is the attacking target of the virtual character BOSS 1. The current position of the virtual character R1 is referred to as the first position, located within the first scene area. The current position of the virtual character BOSS 1 is referred to as the second position, situated within a non-game area of the first game scene.

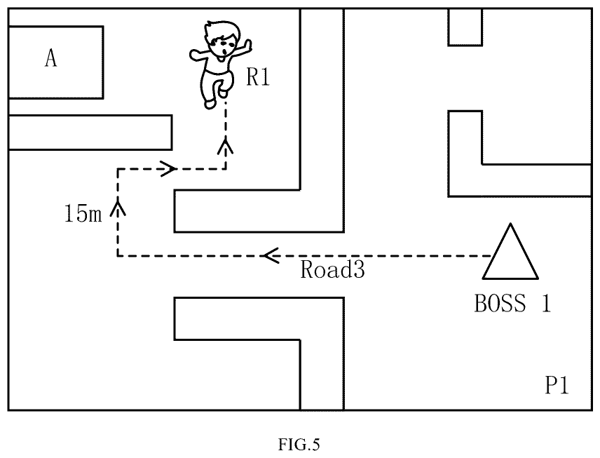

The game interface may also display only a portion of the game area within a game scene, meaning that the first scene area is a portion of the game area. Taking the game interface in FIG. 4 as an example, the scene area P1 is a portion of the game area of the first game scene, the virtual character R1 represents the first virtual character, the virtual character BOSS 1 represents the second virtual character, and the virtual character R1 is the attacking target of the virtual character BOSS 1. The current position of the virtual character R1 is referred to as the first position, which is within the first scene area. The current position of the virtual character BOSS 1 is referred to as the second position, which is within other scene areas of the first game scene other than the first scene area.

In the present embodiment, the proportion of the first scene area within the first game scene may be adjusted based on user's adjustment operations, meaning that it can be increased or decreased. In other words, the user may directly adjust the proportion of the first scene area within the first game scene through a gesture operation withon the game interface, or adjust the proportion of the first scene area within the first game scene via the “Settings” menu of the game. Taking the first game scene in FIG. 4 as an example, the current game interface of the user displays the scene area P1, and the user may present the expansion to the scene area P3 on the game interface by the gesture operation.

Step S220: based on the second position and the first position, performing a first chase directive of the second virtual character towards the first virtual character on the game interface; wherein
the first chase directive includes: displaying, on the game interface, a part of the first movement route taken by the second virtual character towards the first virtual character within the first scene area; wherein the first movement route is determined based on the second position and the first position.

In the present embodiment, the first movement route is the optimal path for the second virtual character to move towards the first virtual character within the first game scene. Generally speaking, this optimal path refers to the shortest path between the second virtual character and the first virtual character while avoiding an obstacle set up in the first game scene.

In the present embodiment, taking the game interface in FIG. 3 as an example, virtual character R1 represents the first virtual character, and its current position is referred to as the first position. Virtual character BOSS 1 represents the second virtual character, and its current position is referred to as the second position, which is located outside the scene area P1. Road1 represents the part of the first movement route taken by the second virtual character towards the first virtual character that lies within the first scene area. The overall length of the first movement route can be displayed on the game interface as 30 m.

In the present embodiment, taking the game scene in FIG. 4 as an example, Road1 represents the part of the first movement route taken by the second virtual character towards the first virtual character that lies within the first scene area, while Road2 represents the part of the first movement route that lies outside the first scene area. The first movement route consists of the combination of paths Road1 and Road2.

In the present embodiment, taking the game scene in FIG. 5 as an example, virtual character R1 represents the first virtual character, and its current position is referred to as the first position. Virtual character BOSS 1 represents the second virtual character, and its current position is referred to as the second position. Moreover, both the first position and the second position are located within the scene area P1. Therefore, Road3 represents the first movement route taken by the second virtual character towards the first virtual character, that is, the part of the first movement route within the first scene area is the first movement route itself. Additionally, the overall length of the first movement route may be displayed on the game interface as 15 m.

In some embodiments, when the second virtual character is still at a considerable distance from the first virtual character, the second virtual character can be represented by a character symbol thereof. This allows to show the general orientation of the second virtual character to the user, thereby further providing effective information for the user's next decision. In a case where the second position is located within a second scene area of the first game scene, the first chase directive further includes: displaying a character symbol representing the second virtual character at a third position within the first scene area; wherein the second scene area is a scene area that is currently not displayed on the game interface, and the third position is determined based on the first position and the second position.

In the present embodiment, the character symbol of the second virtual character is a pattern mark, a text mark, or a combination of a pattern and a text that may represent the character characteristics of the second virtual character, which is not limited herein.

In the present embodiment, the third position may be determined based on the first and second positions. Taking the game scene in FIG. 4 as an example, the first position is the current position of the virtual character R1, and the second position is the current position of the virtual character BOSS 1. The character symbol K1 may be displayed in an edge area of the scene area P1, coinciding with a straight line connecting the first position and the second position. This edge area generally refers to an area within the scene area P1 where the virtual character can move.

The third position may also be determined based on the first movement route derived from the first and second positions. Taking the game scene in FIG. 4 as an example, the first position is the current position of the virtual character R1, and the second position is the current position of the virtual character BOSS 1, Road1 is the first movement route, and the character symbol K2 may be displayed in the edge area of the scene area P1 and near the first movement route.

In other words, in a case where the second position is located within the second scene area of the first game scene, by using the character symbol of the second virtual character to feed back the general orientation of the second virtual character to the user, it is possible for the user to determine the current location of the second virtual character more intuitively. This enables the user to make decisions in advance according to the general orientation of the second virtual character, thereby effectively improving the user's gaming experience.

In some embodiments, in a case where the second position is located within the first scene area of the first game scene, the first chase directive also includes: displaying the second virtual character at the second position within the first scene area. Taking the game interface in FIG. 5 as an example, the virtual character R1 represents the first virtual character, and the virtual character BOSS 1 represents the second virtual character and may move towards the virtual character R1 along Road3.

In some embodiments, to provide the user with more effective information, the first chase directive further includes: marking an actual distance of the first movement route in the first game scene on at least one of the character symbol and the first movement route.

In the present embodiment, taking the game interface in FIG. 3 as an example, Road1 which is the part of the first movement route within the scene area P1, the overall length of the first movement route of 30m which is the actual distance of the first movement route in the first game scene, as well as the character symbol K3 which is the character symbol of the second virtual character, can be displayed within the scene area P1.

According to the method for controlling a virtual character of the first embodiment of the present invention, it addresses the issue in the prior art that it is difficult for the user to perceive the number and orientation of the attacking virtual characters when one or more virtual characters launch an attack on a user-controlled virtual character. Based on this method, when the second virtual character targets the first virtual character as an attack target, it displays the part, which is within the first scene area, of the first movement route of the first virtual character. This clearly shows he first movement route to the user, effectively alerting the user to the chase of the first virtual character by the second virtual character. This feature helps provide the user effective information for making the next decision regarding the first virtual character, thereby enhancing the user's gaming experience.

### Second Embodiment

In the present embodiment, to enhance the user's sense of immersion in the game by integrating game plot events, the first chase directive is initiated for the first virtual character after it triggers some events.

In these embodiments, relative to the above first embodiment, the method further comprises the step S310 as follows:
step S310: initiating the first chase directive based on triggering of a first preset event by the first virtual character within the first scene area.

In the present embodiment, the first preset event is one or more events pre-set in the first game scene. As the user progresses through the game in the first game scene, one or more of these first preset events are triggered.

In some embodiments, in order to enhance the playability of the game as well as enrich the game content, the first preset event is any one event in a preset events set, and the preset events set includes at least one of the following events: the first virtual character moves to a preset position within the first scene area, a staying duration of the first virtual character within the first scene area reaches a preset duration, the number of steps taken by the first virtual character within the first scene area exceeds a preset step count, and the first virtual character completes a preset quest within the first scene area.

In the present embodiment, the preset position, for example, may be any blank position within the first scene area except for obstacles. A blank position generally refers to a position to which the first virtual character can move.

In the present embodiment, after the first virtual character enters the first game scene, the game system records the staying duration of the first virtual character and triggers the first preset event once the preset duration is reached. Here, the preset duration may be 1 minute, 5 minutes, or 10 minutes, and the like, which can be set manually without specific limitations herein.

In the present embodiment, after the first virtual character enters the first game scene, the game system records the number of steps taken by the first virtual character and triggers the first preset event once the preset step count is reached. Here, the preset step count may be 50 steps, 100 steps, or 500 steps, and the like, which can be set manually without specific limitations herein.

In the present embodiment, the preset quests within the first scene area may include actively accepting one or more game quests in the first game scene and passively completing one or more game quests in the first game scene. The first virtual character can actively accept one or more game quests in the first game scene, such as collecting herbs or defeating a certain number of monsters in the first game scene. The first virtual character can also passively complete one or more game quests in the first game scene, such as defeating a specific number of particular monsters or triggering a specific mechanism in the first game scene.

The method for controlling a virtual character according to the second embodiment of the present invention addresses the issue in prior art where, when the virtual character is chased, the user controls the virtual character to escape, focusing solely on the objective of escaping with weak correlation to the plot. Based on the method of the present embodiment, the first preset event and the first chase directive are correlated. This allows the game's plot to be associated with the second virtual character in the game scene. By integrating with the plot, it enriches the game content and enhances the user's gaming experience.

### Third Embodiment

In the present embodiment, in order to further enhance the visual effect presented by the game interface after the preset event is triggered, the first virtual character triggers the preset event, and the second virtual character appears in the first game scene.

In these embodiments, compared with the second embodiment, the step S310 may include the following steps S3101 and S3102:
Step S3101: setting the second virtual character, associated with the first game scene, to appear in the first game scene based on triggering of a first preset event by the first virtual character within the first scene area.

In the present embodiment, different first preset events may be set in the first game scene, and may be associated with different second virtual characters or the same second virtual character. One first preset event may be associated with the presence of one or more second virtual characters, or some first preset events may be associated with the presence of one or more second virtual characters after they are triggered. Here, the plurality of the second virtual characters may be characters with the same attributes and character models, characters with different attributes but the same character model, and characters with different attributes and different character models.
Step S3102: initiating the first chase directive based on appearance of the second virtual character in the first game scene.

In the present embodiment, taking the game scene in FIG. 4 as an example, the virtual character BOSS 1 is the second virtual character, and when the virtual character BOSS 1 appears in the first game scene, the first chase directive is initiated. Moreover, the prompt information and animation effect of the virtual character BOSS 1 may be displayed on the game interface.

### Fourth Embodiment

In the present embodiment, in order to further enrich the content of the game, the second virtual character will chase the first virtual character over time. However, after certain other preset events occur, the second virtual character will cease chasing the first virtual character.

In these embodiments, compared with the first embodiment, the step S220 may include the following step S2201 and step S2202:
Step S2201: at a first time point, performing a first chase directive corresponding to the first time point based on a second position of the second virtual character at the first time point and a first position of the first virtual character at the first time point;
Step S2202: at a second time point, performing a first chase directive corresponding to the second time point based on a second position of the second virtual character at the second time point and a first position of the first virtual character at the second time point;
wherein the second time point is after the first time point, and in a case where a second preset event occurs, an actual movement route of the second virtual character from the first time point to the second time point deviates from a first movement route directed by the first chase directive corresponding to the first time point.

In the present embodiment, the second preset event may be triggered by the first virtual character, the fourth virtual character, the game system, or the second virtual character, which is not limited herein. Taking the scenario where the second preset event is triggered by the first virtual character as an example, the second preset event may be that the first virtual character moves to the preset position within the first scene area, may be that the staying duration of the first virtual character within the first scene area reaches the preset duration, may be that the number of steps taken by the first virtual character within the first scene area exceeds the preset step count, or may be that the first virtual character has completed the preset quest within the first scene area. Here, the fourth virtual character may be another virtual character other than first virtual character controlled by the user, may be an attendant character of the first virtual character, or may be a virtual character controlled by another user or the game system.

In the present embodiment, different second preset events may be set in the first game scene, and may be associated with different second virtual characters or the same second virtual character. One single second preset event may be associated with one or more second virtual characters deviating from a first movement route at the first time point. Alternatively, some second preset events, after they are triggered, may be associated with one or more second virtual characters deviating from a first movement route at the first time point.

In the present embodiment, when the second virtual character deviates from the first moving route corresponding to the first chase directive at the first time point, the game interface still displays the part of the first movement route taken by the second virtual character towards the first virtual character within the first scene area.

In the present embodiment, taking the game scene in FIG. 4 as an example, the first virtual character is the virtual character R1, the second virtual character is the virtual character BOSS 1, the first time point is 9 o'clock, and the second time point is 9:30. At 9 o'clock, the virtual character BOSS 1 chases the virtual character R1 along the first movement route. At 9:30, the second preset event is triggered, and the channel Z1 is unlocked, allowing the virtual character BOSS 1 to move along Road4, thereby deviating from the first movement route that corresponded to the first chase directive at the first time point.

### Fifth Embodiment

In the present embodiment, in order to further enrich the content of the game, a plurality of game scenes are provided in the game. The user may control the first virtual character to switch to the new game scene. If some second virtual characters that are chasing the first virtual character are remain alive, they can continue to chase the first virtual character in the new game scene to achieve the purpose of enriching the content of the game.

In these embodiment, compared with the first embodiment, the method may further include the following step S410 to step S430:
Step S410: in response to the first virtual character switching to a second game scene, displaying a third scene area of the second game scene on the game interface; wherein the first virtual character is located in the third scene area;

In the present embodiment, the step S410 may be that: in response to the first virtual character switching to a second game scene, displaying a third scene area of the second game scene on the game interface; wherein the first virtual character is located in the fourth position within the third scene area.

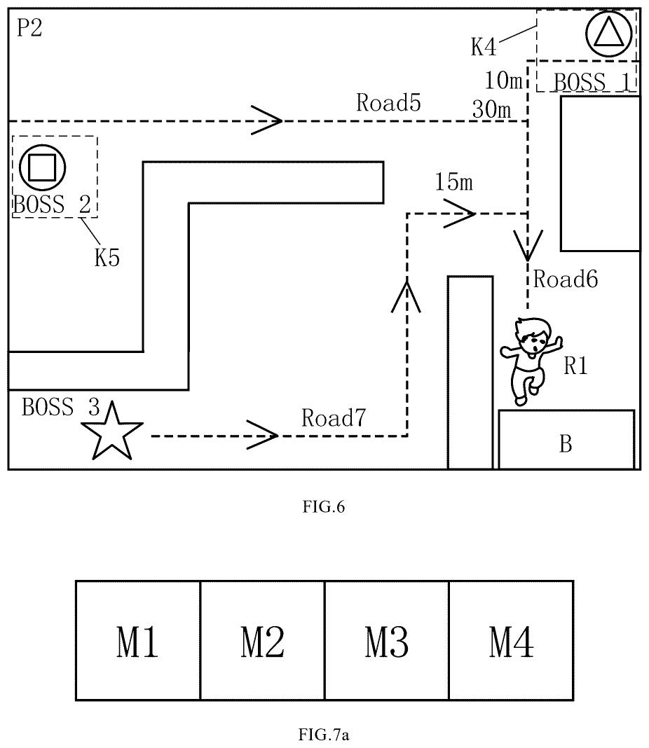

In the present embodiment, the first virtual character may enter the second game scene from the first game scene in one or more set switching manners. For example, taking the game interface shown in FIGS. 5 and 6 as an example, the virtual character R1 may move to the area A of the scene area P1, and then is switched to the area B of the scene area P2. That is, the scene area P2 is the third scene area of the second game scene, and the current position of the virtual character R1 in the second game scene is referred to as the fourth position.

For another example, the user is provided with a teleporting item, which may enable the first virtual character to teleport from a certain position in the first game scene to a certain position in the second game scene.

For another example, a trap is pre-set at a specific position in the first game scene, and when the first virtual character moves to the specific position, the first virtual character is teleported to a corresponding position in another game scene associated with the specific position.
Step S420: in a case where the second virtual character is still alive in the first game scene, causing the second virtual character to appear in the second game scene.

In the present embodiment, the positions where the second virtual character appears in different game scenes may be positions preset by the game system, and the preset positions here may be one or more. In the case where the preset position is one, the second virtual character appears at this single preset position in the second game scene. In the case where the preset positions are plural, the second virtual character appears at one of these preset positions in the second game scene.

In the present embodiment, the step S410 may be that in the case where the second virtual character is still alive in the first game scene, determining a fifth position at which the second virtual character appears in the second game scene according to the orientation relationship set between the first game scene and the second game scene.

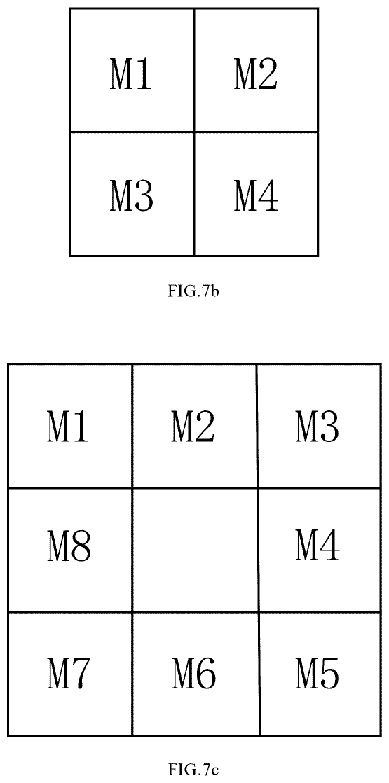

In the present embodiment, in the game, the layout of the game scene may be pre-configured, such as “□” shape in FIG. 7A, “□” shape in FIG. 7B, or “□” shape in FIG. 7c. That is, there is a preset positional relationship between the plurality of game scenes, which establishes a determined orientation relationship between the first game scene and the second game scene. Taking the layout in FIG. 7b as an example, the first game scene is the game scene M1, the second game scene is the game scene M3, and therefore the game scene M1 is right above the game scene M3.
Step S430: performing a second chase directive of the second virtual character towards the first virtual character on the game interface.

In the present embodiment, step S430 may be that performing a second chase directive of the second virtual character towards the first virtual character on the game interface based on the fourth position and the fifth position. The second chase directive may include: displaying on the game interface a part of the second movement route within the third scene area, which is the path the second virtual character takes to chase the first virtual character; wherein, the second movement route is determined based on the fifth location and the fourth location. In a case where the fifth position is located within the fourth scene area of the second game scene, the second chase directive further includes: displaying a character symbol representing the second virtual character at the sixth position of the third scene area; wherein, the fourth scene area is a scene area not currently displayed on the game interface, and the sixth position is determined based on the fourth position and the fifth position.

In the present embodiment, one game scene may set one or more fifth positions for the appearance of the second virtual characters from other game scenes. Taking the game interface shown in FIG. 6 as an example, three second virtual characters are the virtual character BOSS 1, the virtual character BOSS 2 and the virtual character BOSS 3 respectively, which appear at their respective corresponding fifth positions in the second game scene.

In the present embodiment, taking the game interface shown in FIG. 6 as an example, the virtual character R1 is switched to the scene area P2 of the second game scene, and at this time, the virtual character BOSS 1 is still alive. Then, the virtual character BOSS 1 may chase the virtual character R1 at the fourth position from the fifth position where the virtual character BOSS 1 is currently located.

In the present embodiment, taking the game interface shown in FIG. 6 as an example, the fifth position where the virtual character BOSS 1 appears is in the fourth scene area outside the third scene area of the second game scene. The game interface may present the character symbol K4 of the virtual character BOSS 1, i.e., the character symbol of the second virtual character, at the sixth position of the third scene area, and also presents the Road6 of the virtual character BOSS 1 chasing the virtual character R1 in the third scene area, that is, a part of the second movement route within the third scene area, which is the path of the second virtual character takes to chase the first virtual character.

In some embodiments, in order to further enhance the visual effect of the game, a third preset event is set in the second game scene, so that the third virtual character can appear at the seventh position in the second game scene when the first virtual character triggers the third preset event. The method further includes: based on triggering of the third preset event in the third scene area by the first virtual character, setting the third virtual character associated with the second game scene to appear in a seventh position in the second game scene; based on appearance of the third virtual character in the second game scene, initiating a third chase directive. The third chase directive of the third virtual character to the first virtual character is performed on the game interface based on the fourth position and the seventh position.

In the present embodiment, taking the game interface in FIG. 6 as an example, both the virtual character BOSS 2 and the virtual character BOSS 3 are third virtual characters. The seventh position of the virtual character BOSS 2 is within the fifth scene area outside the third scene area in the second game scene. The game interface can present Road5 of the virtual character BOSS 2 chasing the virtual character R1, and the character symbol K5 of the virtual character BOSS 2. The seventh position of the virtual character BOSS 3 is within the third scene area, and the game interface can present the virtual character BOSS 3 and Road7 of the virtual character BOSS 3 chasing the virtual character R1.

### Sixth Embodiment

In the present embodiment, to reduce the demand for data retrieval of virtual characters in the game scene and thereby enhance the smoothness of game operation, a virtual entity identical to the character model of the second virtual character is created in the second game scene. This allows the second virtual character to continue chasing the first virtual character in the second game scene while improving the smoothness of game operations.

In these embodiments, compared with the above first embodiment, the method further includes the following step S510:
Step S510: in response to the first virtual character switching to a second game scene, displaying a third scene area of the second game scene on the game interface; wherein the second game scene includes the first virtual character, and the second virtual character that targets the first virtual character as an attack target, with the first virtual character located within the third scene area, and while a second virtual character in the first game scene and a second virtual character in the second game scene are different virtual individuals, they share the same character model.

In the present embodiment, a game scene may create virtual individuals of a character model for virtual characters in other game scenes. Taking the game interface in FIG. 6 as an example, the virtual character BOSS 1 presented in the third scene area is a virtual individual created in the second game scene that is the same as the character model of the virtual character BOSS 1.

### Apparatus Embodiment

FIG. 8 illustrates a structural schematic diagram of the configuration of an apparatus 800 for controlling a virtual character according to the embodiment of the present disclosure, and the present embodiment takes the first virtual character being chased as an example to describe the configuration of this apparatus. As shown in FIG. 8, the apparatus 800 for controlling a virtual character includes a display Module 810 and a directing module 820.

The display module 810 is configured for displaying a first scene area of a first game scene on a game interface; wherein the first game scene includes a user-controlled first virtual character, and a second virtual character that targets the first virtual character as an attack target, with the first virtual character located at a first position within the first scene area, and the second virtual character located at a second position within the first game scene;

The directing module 820 is configured for based on the second position and the first position, performing a first chase directive of the second virtual character towards the first virtual character on the game interface; the first chase directive includes: displaying, on the game interface, a part of the first movement route taken by the second virtual character towards the first virtual character within the first scene area; wherein the first movement route is determined based on the second position and the first position.

Optionally, the apparatus 800 for controlling a virtual character further includes an initiating module, which is configured for initiating the first chase directive based on triggering of a first preset event by the first virtual character within the first scene area.

Optionally, the initiating module is further configured for setting the second virtual character, associated with the first game scene, to appear in the first game scene based on triggering of a first preset event by the first virtual character within the first scene area; and initiating the first chase directive based on appearance of the second virtual character in the first game scene.

Optionally, the directing module 820 is further configured for at a first time point, performing a first chase directive corresponding to the first time point based on a second position of the second virtual character at the first time point and a first position of the first virtual character at the first time point; at a second time point, performing a first chase directive corresponding to the second time point based on a second position of the second virtual character at the second time point and a first position of the first virtual character at the second time point; wherein the second time point is after the first time point, and in a case where a second preset event occurs, an actual movement route of the second virtual character from the first time point to the second time point deviates from a first movement route directed by the first chase directive corresponding to the first time point.

Optionally, the apparatus 800 for controlling a virtual character further includes a first switching module, which is configured for in response to the first virtual character switching to a second game scene, displaying a third scene area of the second game scene on the game interface; wherein the first virtual character is located in the third scene area; in a case where the second virtual character is still alive in the first game scene, causing the second virtual character to appear in the second game scene; and performing a second chase directive of the second virtual character towards the first virtual character on the game interface.

Optionally, the apparatus 800 for controlling a virtual character further includes a second switching module, which is configured for in response to the first virtual character switching to a second game scene, displaying a third scene area of the second game scene on the game interface; wherein the second game scene includes the first virtual character, and the second virtual character that targets the first virtual character as an attack target, with the first virtual character located within the third scene area, and while a second virtual character in the first game scene and a second virtual character in the second game scene are different virtual individuals, they share the same character model.

### Device Embodiment

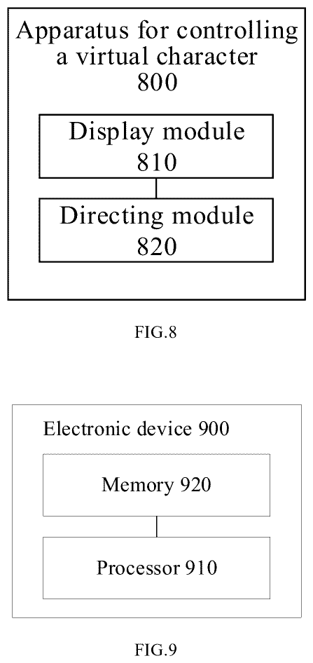

FIG. 9 illustrates a schematic diagram of the hardware structure of the electronic device according to other embodiments. As shown in FIG. 9, the electronic device 900 comprises a processor 910 and a memory 920, the memory 920 is configured for storing a computer program, and the computer program is used to control the processor 910 to operate, so as to control the electronic device 900 to perform the method for controlling a virtual character according to any embodiment of the present disclosure. The electronic device 900 may be a user terminal used by a game user when performing the method steps according to the first embodiment to the sixth embodiment.

Embodiments of the present disclosure also provide a computer-readable storage medium storing a computer program that, when executed by a processor, implements the information processing method for a battle game according to any embodiment of the present disclosure.

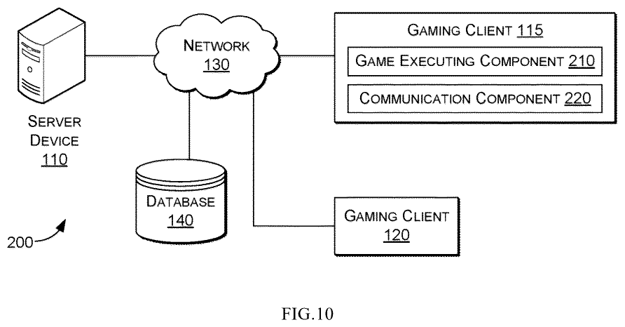

Turning now to FIG. 10, a schematic depiction is provided illustrating one exemplary operating environment 200 of which an embodiment of the present disclosure can be employed. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The operating environment 200 of FIG. 10 includes a server device 110 that provides a service to one or more client devices, such as gaming clients 115,120, for instructing game play and/or settings in a virtual gaming environment over a network 130, such as the Internet. The gaming clients 115,120 may implement a computerized system for controlling a virtual character in a game. In some embodiments, the gaming clients 115,120 may be mobile electronic devices having touchscreens thereon, such as smart phones, tablets, or laptop computers. The server device 110 and the gaming clients 115,120 may communicate in a wired or wireless manner over the network 130.

In some embodiments, the server device 110 is coupled, directly or indirectly, to a database 140 for facilitating the storage and querying of records corresponding to a plurality of game play instructions, actions, objects (e.g., virtual game pieces/characters, weapons, buildings, etc.), maps, and/or settings. The database 140 includes, among other things, a relational database or similar storage structure accessible by the server device 110. In accordance with embodiments described herein, the database 140 stores a plurality of records that each corresponds to game play instructions, actions, objects, maps, and/or settings.

The server device 110 includes a gaming server accessible by any of the gaming clients 115,120 and/or a data server for supporting an application of any of the gaming clients 115,120, over the network 130. The gaming server can support any type of application, including those that facilitate live game play. The server device 110 can further determine relationships (e.g., teams) between the gaming clients 115,120. In various embodiments, the server device 110 communicates actions commanded via one or more of the gaming clients 115,120, to another one or more of the gaming clients 115,120 for presentation thereon via user interfaces or the like, as later described herein.

Network 130 may be wired, wireless, or both. Network 130 may include multiple networks, or a network of networks, but is shown in simple form so as not to obscure aspects of the present disclosure. By way of example, network 130 can include one or more wide area networks (WANs), one or more local area networks (LANs), one or more public networks, such as the Internet, one or more private networks, and/or one or more telecommunications networks. Where network 130 includes a wireless telecommunications network, components such as a base station, a communications tower, or even access points (as well as other components) may provide wireless connectivity. Networking environments are commonplace in enterprise-wide computer networks, intranets, and the Internet. Accordingly, network 130 is not described in significant detail.

In accordance with embodiments of the present disclosure, the server device 110 or the gaming clients 115, 120 can each be a computing device that is capable of accessing the Internet, such as the World Wide Web, and/or a telecommunications network. Either one of the server device 110 or the gaming clients 115, 120 might take on a variety of forms, such as a personal computer (PC), a laptop computer, a mobile phone, a tablet computer, a wearable computer, a personal digital assistant (PDA), an MP3 player, a global positioning system (GPS) device, a video player, a handheld communications device, a smartphone, a smart watch, a workstation, any combination of these delineated devices, or any other suitable device.

It should be understood that any number of the aforementioned devices may be employed in operating environment 200 within the scope of the present disclosure. Each may comprise a single device or multiple devices cooperating in a distributed environment. Additionally, other components not shown may also be included within the distributed environment. It should further be understood that operating environment 200 shown in FIG. 10 is an example of one suitable computing system architecture. Each of the servers, gaming clients, networks, and databases shown in FIG. 10 may be implemented via a computing device, such as computing device 600. The components may communicate with each other via network 130.

FIG. 10 also depicts operational modules of an exemplary one of the gaming clients, specifically gaming client 115, in accordance with some embodiments of the present disclosure. It is noted that the depicted implementation is merely exemplary, and not intended to be limiting in any way, as each component can be arranged in various configurations, spread across a number of computing devices, combined with other components or one another, arranged to communicate over a network, or any combination of the foregoing including others not mentioned. For example, each of the operational modules may comprise a combination of hardware components and/or computer instructions stored on computer-readable media or a memory and executable on a processor thereof.

As depicted in FIG. 10, the operational modules of the gaming client 115 may comprise a game executing component 210 and a communication component 220. The game executing component 210 can be configured for executing a battle game as described above. The communication component 220 can be configured for network communications between the gaming client 115, the gaming client 120, and/or the server device 110 via network 130.

The various embodiments described in this specification are presented in a progressive manner. The same and similar parts between each embodiment can refer to each other, and each embodiment focuses on the differences from other embodiments. Especially for the embodiment of the device and the apparatus, because they are basically similar to the method embodiment, the description is relatively simple, and the relevant part can be referred to the part of the method embodiment.

The specific embodiments of this specification have been described above. Other embodiments fall within the scope of the appended claims. In some cases, the actions or steps recorded in the claims can be executed in an order different from that of the embodiments and still achieve the desired results. Additionally, processes depicted in the diagrams do not necessarily require the particular order or continuous sequence shown to achieve the desired outcome. In certain implementations, multitasking and parallel processing are also possible or may be advantageous.

Embodiments of this specification can be devices, methods, and/or computer program products. A computer program product may comprise a computer-readable storage medium having computer-readable program instructions carried thereon for enabling processors to implement various aspects of the embodiments described in this specification.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium comprises the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments of this specification may be assembler instructions, instruction-set-architecture (ISA) instructions, machine instructions, machine dependent instructions, microcode, firmware instructions, state-setting data, or either source code or object code written in any combination of one or more programming languages, comprising an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, comprising a local area network (LAN) or a wide area network (WAN), or the connection may be made to an external computer (for example, through the Internet using an Internet Service Provider). In some embodiments, electronic circuitry comprising, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of embodiments of this specification are described herein with reference to flowchart illustrations and/or block diagrams of methods, apparatus (systems), and computer program products according to embodiments of this specification. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture comprising instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of this specification. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. It is well-known to a member skilled in the art that the implementations of using hardware, using software or using the combination of software and hardware can be equivalent.

Embodiments of this specification have been presented for illustrative purposes, and are not intended to be exhaustive or limited to the disclosed embodiments. Various modifications and changes will be apparent to those skilled in the art without departing from the scope and spirit of the disclosed embodiments. The terminology used herein is chosen to best explain the principles of the embodiments, their practical applications or technical improvements they offer over existing technologies, thereby enabling others of ordinary skill in the art to understand the embodiments disclosed herein.

1. A method for controlling a virtual character for implementation by a device that executes a game, comprising:
displaying, on a game interface by a processor, a first scene area of a first game scene; wherein the first game scene comprises a user-controlled first virtual character and a second virtual character configured to attack the first virtual character, the first virtual character being located at a first position within the first scene area, and the second virtual character being located at a second position within the first game scene; and
performing, based on the second position and the first position by the processor, a first chase directive of the second virtual character towards the first virtual character on the game interface;
wherein the first chase directive comprises: displaying, on the game interface by the processor, a part of a first movement route taken by the second virtual character towards the first virtual character within the first scene area; wherein the first movement route is determined based on the second position and the first position.

2. The method according to claim 1, wherein if where the second position is located within a second scene area of the first game scene, the first chase directive further comprises: displaying, on the game interface by the processor, a character symbol representing the second virtual character at a third position within the first scene area;
wherein the second scene area is currently not displayed on the game interface, and the third position is determined based on the first position and the second position.

3. The method according to claim 1, further comprising:
initiating, by the processor, the first chase directive based on triggering of a first preset event by the first virtual character within the first scene area.

4. The method according to claim 3, wherein the initiating, by the processor, the first chase directive based on triggering of the first preset event by the first virtual character within the first scene area, comprises:
setting, by the processor, the second virtual character, associated with the first game scene, to appear in the first game scene based on triggering of the first preset event by the first virtual character within the first scene area; and
initiating, by the processor, the first chase directive based on appearance of the second virtual character in the first game scene.

5. The method according to claim 3, wherein the first preset event is one event in a preset events set, and the preset events set comprises at least one of:
the first virtual character moves to a preset position within the first scene area;
a staying duration of the first virtual character within the first scene area reaches a preset duration;
a quantity of steps taken by the first virtual character within the first scene area exceeds a preset step count; and
the first virtual character completes a preset quest within the first scene area.

6. The method according to claim 2, wherein the first chase directive further comprises: marking, by the processor, an actual distance of the first movement route in the first game scene on at least one of the character symbol and the first movement route.

7. The method according to claim 1, wherein the performing a first chase directive of the second virtual character towards the first virtual character, comprises:
performing, at a first time point by the processor, the first chase directive corresponding to the first time point based on a second position of the second virtual character at the first time point and a first position of the first virtual character at the first time point;
performing, at a second time point after the first time point by the processor, the first chase directive corresponding to the second time point based on a second position of the second virtual character at the second time point and a first position of the first virtual character at the second time point;
wherein if a second preset event occurs, an actual movement route of the second virtual character from the first time point to the second time point deviates from the first movement route directed by the first chase directive corresponding to the first time point.

8. The method according to claim 1, further comprising:
displaying, on the game interface by the processor, a third scene area of a second game scene, in response to the first virtual character switching to the second game scene; wherein the first virtual character is located in the third scene area;
triggering, by the processor, the second virtual character to appear in the second game scene if the second virtual character is still alive in the first game scene; and
performing, on the game interface by the processor, a second chase directive of the second virtual character towards the first virtual character.

9. The method according to claim 1, further comprising:
displaying, on the game interface by the processor, a third scene area of the second game scene on the game interface, in response to the first virtual character switching to a second game scene; wherein the second game scene comprises the first virtual character and the second virtual character configured to attack the first virtual character, with the first virtual character located within the third scene area, and a second virtual character in the first game scene and a second virtual character in the second game scene share the same character model, while being different virtual individuals.

10. A computerized system for controlling a virtual character in a game, comprising:
an interface display;
a memory, configured for storing a computer program; and
a processor, configured for executing a method for controlling virtual characters according to claim 1, under control of the computer program.

11. The system according to claim 10, wherein if where the second position is located within a second scene area of the first game scene, the first chase directive further comprises: displaying, on the game interface by the processor, a character symbol representing the second virtual character at a third position within the first scene area;
wherein the second scene area is currently not displayed on the game interface, and the third position is determined based on the first position and the second position.

12. The system according to claim 10, further comprising:
initiating, by the processor, the first chase directive based on triggering of a first preset event by the first virtual character within the first scene area.

13. The system according to claim 12, wherein the initiating, by the processor, the first chase directive based on triggering of the first preset event by the first virtual character within the first scene area comprises:
setting, by the processor, the second virtual character, associated with the first game scene, to appear in the first game scene based on triggering of the first preset event by the first virtual character within the first scene area; and
initiating, by the processor, the first chase directive based on appearance of the second virtual character in the first game scene.

14. The system according to claim 12, wherein the first preset event is one event in a preset events set, and the preset events set comprises at least one of:
the first virtual character moves to a preset position within the first scene area;
a staying duration of the first virtual character within the first scene area reaches a preset duration;
a quantity of steps taken by the first virtual character within the first scene area exceeds a preset step count; and
the first virtual character completes a preset quest within the first scene area.

15. The system according to claim 11, wherein the first chase directive further comprises: marking, by the processor, an actual distance of the first movement route in the first game scene on at least one of the character symbol and the first movement route.

16. The system according to claim 10, wherein the performing a first chase directive of the second virtual character towards the first virtual character, comprises:
performing, at a first time point by the processor, the first chase directive corresponding to the first time point based on a second position of the second virtual character at the first time point and a first position of the first virtual character at the first time point;
performing, at a second time point after the first time point by the processor, the first chase directive corresponding to the second time point based on a second position of the second virtual character at the second time point and a first position of the first virtual character at the second time point;
wherein if a second preset event occurs, an actual movement route of the second virtual character from the first time point to the second time point deviates from the first movement route directed by the first chase directive corresponding to the first time point.

17. The system according to claim 10, further comprising:
displaying, on the game interface by the processor, a third scene area of a second game scene, in response to the first virtual character switching to the second game scene; wherein the first virtual character is located in the third scene area;
triggering, by the processor, the second virtual character to appear in the second game scene if the second virtual character is still alive in the first game scene; and
performing, on the game interface by the processor, a second chase directive of the second virtual character towards the first virtual character.

18. The system according to claim 10, further comprising:
displaying, on the game interface by the processor, a third scene area of the second game scene on the game interface, in response to the first virtual character switching to a second game scene; wherein the second game scene comprises the first virtual character and the second virtual character configured to attack the first virtual character, with the first virtual character located within the third scene area, and a second virtual character in the first game scene and a second virtual character in the second game scene share the same character model, while being different virtual individuals.

19. A non-transitory computer-readable storage medium for storing instructions, wherein when executed by a processor, the instructions instruct the processor to perform a method for controlling a virtual character in a game according to claim 1.

20. The non-transitory computer-readable storage medium of claim 19, comprising:
displaying, on the game interface by the processor, a character symbol representing the second virtual character at a third position within the first scene area, if the second position is located within a second scene area of the first game scene;
wherein the second scene area is currently not displayed on the game interface, and the third position is determined based on the first position and the second position.
